(19) United States
(12) Patent Application Publication
(10) Pub. No.: US 2008/0068298 A1
(43) Pub. Date: Mar. 20, 2008

(54) System and method for constant power LED driving and a redundancy dircuit thereof

(75) Inventors: Yuhren Shen, Hsinchu (TW); Hung-Chi Chu, Hsinchu (TW); Chun-Chi Chen, Hsinchu (TW); Yu-Hsien Chang, Hsinchu (TW)

Correspondence Address: BACON & THOMAS, PLLC, 625 SLATERS LANE, FOURTH FLOOR, ALEXANDRIA, VA, 22314, US

(73) Assignee: VastView Technology Inc., Hsinchu (TW)

(21) Appl. No.: 11/600,852

(22) Filed: Nov. 17, 2006

(30) Foreign Application Priority Data
Sep. 18, 2006 (TW) 095134478

(51) Int. Cl. G09G 3/14

(52) U.S. Cl. 345/46

(57) ABSTRACT

A constant power DC light emitting diode (LED) driving system and method is disclosed. The system comprises a plurality of LED, a DC voltage source for LED current generation, and a constant-voltage and constant-current regulator for constant luminance control. A method and a redundancy circuit thereof for LED current detouring and LED luminance maintenance are also disclosed.

### BACKGROUND OF THE INVENTION

1. Field of the Invention

The present invention is related to a system and method for light emitting diode (LED) driving, and more particularly to a system and method for constant power driving of which the driven LED(s) could be plural and has no need of special producing treatment for uniform luminance character.

2. Description of the Prior Art

LED is a p-n junction in semiconductor. Under a forward-bias driving, photons are created from the recombination of hole-electron pair at the p-n junction. The generating rate of photon numbers is therefore proportional to the forward-biased current through the p-n junction. Note that the larger forward-biased current is the higher emitting intensity. Conventionally, constant-voltage driving (FIG. 10A), constant-current driving (FIG. 10B) and AC driving (FIG. 10C) are the ways to generate a constant current for LED illuminating. In constant-voltage driving system, LED current varied with the resistor 91 is very sensitive to DC voltage source due to the nonlinearity of LED current-to-voltage (I-V) curve. Besides, a rise in ambient temperature from heat of LED luminance also changes the I-V curve. If we want to use the conventional constant-voltage driving system to supply a constant power LED luminance, a very steady DC voltage source and an LED cooling system are therefore needed. In constant-current driving system, a current source 92 is connected in series to supply a constant LED current. Although the current source can supply a more stable LED current for constant power luminance, it is not robust for peripheral condition changes (e.g. change of I-V curve) either. An AC driving system comprising an AC power source and a diode in series is combined with a LED in parallel for home electrical outlet usage. In order to smear the waved directional voltage, a capacitance is connected with the LED in parallel. Obviously, in conventional AC driving system, the LED is more vulnerable to home power supply.

In recent years, the developing technologies of higher luminance and multicolor lead the appliances of LED to diversiform fields, such as light source, guidance lamp, LED back light module, signal lamp, display panel, and etc. In the near future, LED could be the major light source instead of traditional compact fluorescent lamp (CFL). In order to well control LED luminosity in the advanced appliances, an advanced LED driver satisfying the needs of circuit miniaturization, high stability, high efficiency, multi-LED driving supply, and battery life extension is imperiously needed. In conventional driving system, LED current cannot get a well control for suffering voltage spikes and ripples. The worse is the luminance character (I-V curve) has a wide distribution during mass production. For precisely LED luminance control, disposing an individual driver for every LED is a presumable solution. However, it will cost too much and waste chip space. Therefore, an advanced, robust, and economic LED driver is highly urgent in advanced luminance control.

### SUMMARY OF THE INVENTION

The main objective of the present invention is to provide a system and method for constant power LED driving, wherein a constant-voltage and constant-current regulator for precisely control of luminance power is used. With the constant-voltage and constant-current regulator and a DC voltage source, it becomes more convenient to use home electrical outlet on LED luminance driving. Further, the constant-voltage and constant-current regulator can clamp LED voltage and current both, and thereby the present invention is a robust and economic LED driving method and system even for multi-LED luminance control.

A further objective of the present invention is to provide a redundancy circuit, for combining with the LED set so as to provide an LED current detour to maintain LED luminance even under LED harm.

In order to achieve the said objectives, a LED driving method for constant luminance power according to the present invention comprises: applying a DC voltage V_{LD}_{_{—}}_{DC} from a DC voltage source 110 on an LED set 120 to generate an LED current I_{LED} for LED luminance, wherein the LED current is controlled by a constant-voltage and constant-current regulator 130 for LED voltage differential and current clamping even under any tough situation such as voltage spike, voltage and current ripples, rising ambient temperature or other factors to change luminance characters (I-V curve).

A LED driving system for constant luminance power according to the present invention comprises: a DC voltage source 110 for DC voltage V_{LED}_{_{—}}_{DC} supply; an LED set 120 connected to the DC voltage source for LED current I_{LED} generating; and a constant-voltage and constant-current regulator 130 connected with the LED set for LED voltage differential and current clamping even under any tough situation such as voltage spike, voltage and current ripples, rising ambient temperature or other factors to change luminance characters (I-V curve).

A redundancy circuit according to the present invention comprises a detour for LED current and a redundancy controller combined with the LED set so as to maintain the LED luminance without any effects of LED harm.

The present invention will be apparent after reading the detailed description of the preferred embodiments hereinafter in reference to the accompanying drawings.

### BRIEF DESCRIPTION OF THE DRAWINGS

FIG. 1 shows sketch of the LED driving method and system in the present invention.

FIG. 2 shows a process of the constant-current circuit of the LED driving method in the present invention.

FIG. 3 is a circuit diagram showing a first embodiment of LED driving system in the present invention.

FIG. 4 is a circuit diagram showing a second embodiment of LED driving system in the present invention.

FIG. 5 is a circuit diagram showing an embodiment of current source of LED driving system in the present invention.

FIG. 6A is a circuit diagram showing a first embodiment of current sink of LED driving system in the present invention.

FIG. 6B is a circuit diagram showing a second embodiment of current sink of LED driving system in the present invention.

FIG. 6C is a circuit diagram showing a third embodiment of current sink of LED driving system in the present invention.

FIG. 7A is a circuit diagram showing an embodiment of LED driving system using all bridge rectifiers in the present invention.

FIG. 7B is a circuit diagram showing a first embodiment of all bridge rectifiers in the present invention.

FIG. 7C is a circuit diagram showing a second embodiment of all bridge rectifiers in the present invention.

FIG. 7D is a circuit diagram showing a third embodiment of all bridge rectifiers in the present invention.

FIG. 7E is a circuit diagram showing a fourth embodiment of all bridge rectifiers in the present invention.

FIG. 8A is a circuit diagram showing an embodiment of LED driving system using half bridge rectifier in the present invention.

FIG. 8B is a circuit diagram showing a first embodiment of half bridge rectifier in the present invention.

FIG. 8C is a circuit diagram showing a second embodiment of half bridge rectifier in the present invention.

FIG. 8D is a circuit diagram showing a third embodiment of half bridge rectifier in the present invention.

FIG. 9A is a circuit diagram showing a LED driving system with redundancy circuit in the present invention.

FIG. 9B shows the I-V curve of a silicon controlled rectifier (SCR).

FIG. 9C is a circuit diagram showing a first embodiment of detour circuit of redundancy circuit in the present invention.

FIG. 9D is a circuit diagram showing a second embodiment of detour circuit of redundancy circuit in the present invention.

FIG. 9E is a circuit diagram of a third embodiment of detour circuit of redundancy circuit in the present invention.

FIG. 9F is a circuit diagram showing a fourth embodiment of detour circuit of redundancy circuit in the present invention.

FIG. 9G is a circuit diagram showing a fifth embodiment of detour circuit of redundancy circuit in the present invention.

FIG. 9H is a circuit diagram showing a sixth embodiment of detour circuit of redundancy circuit in the present invention.

FIG. 10A shows a sketch of a conventional constant-voltage driving system.

FIG. 10B shows a sketch of a conventional constant-current driving system.

FIG. 10C shows a sketch of a conventional AC driving system.

### DETAILED DESCRIPTION OF THE PREFERRED EMBODIMENTS

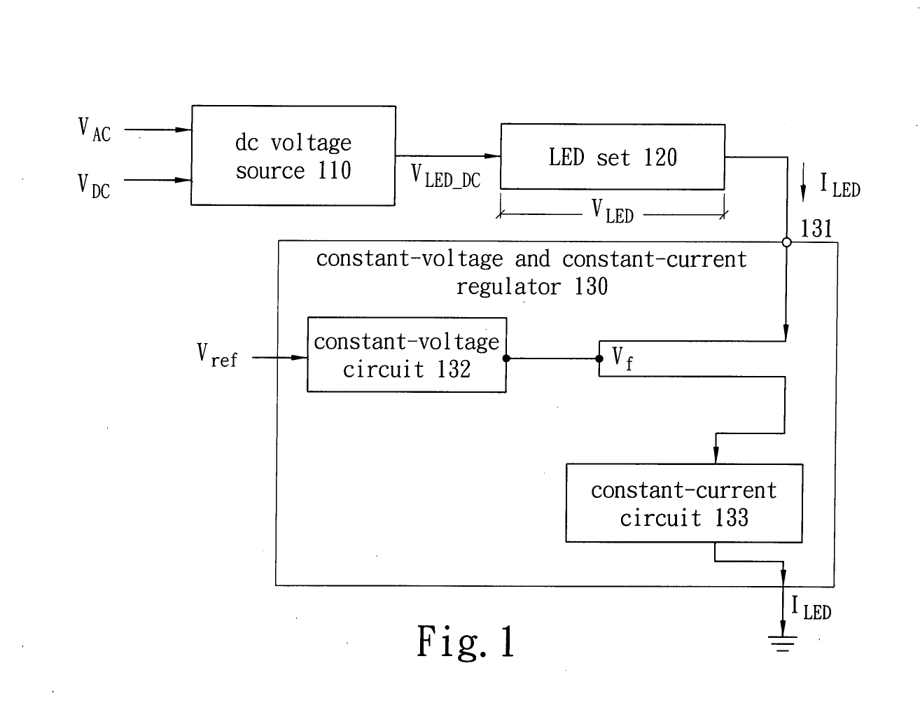

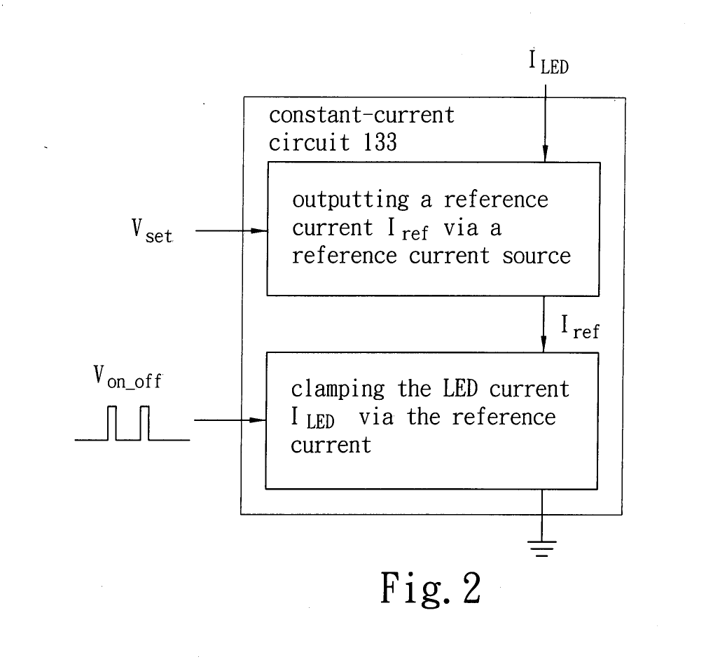

An LED driving method for constant luminance power according to the present invention (please see FIG. 1) comprises the following steps: first, applying an DC voltage V_{LED}_{_{—}}_{DC} from a DC voltage source 110 on an LED set 120 to generate an LED current I_{LED} for LED luminance, wherein the LED set could be a single LED or multi-LED in series; second, controlling the LED current by a constant-voltage and constant-current regulator 130 for LED voltage differential and current clamping even under any tough situation such as voltage spike, voltage and current ripples, rising ambient temperature or other factors to change luminance characters (I-V curve); third, providing constant-voltage and constant-current regulator, the LED current through an output 131 is accepted; the output voltage V_{f} is clamped by a constant-voltage circuit 132; the extra voltage during voltage spike, ripple and so on is absorbed by a constant-voltage transistor 236, 237; and the LED current I_{LED} is clamped to an anticipate LED current via a constant-current circuit 133 too. For adjustment of the output voltage V_{f}, a reference voltage V_{ref} is used in the constant-voltage circuit. In the constant-current circuit 133 (please see FIG. 2), a setting voltage Vₛₑₜ and a setting resistor Rₛₑₜ are used for reference current I_{ref} adjustment, where I_{ref} is the referent current for LED current clamping. In order to control luminance power in AC on-off frequency, a switch transistor with functional gate voltage Vₒₙ_{_{—}}_{off} is used in the constant-current circuit.

The first embodiment of providing DC voltage source in the LED driving method comprises: converting an AC voltage V_{AC} to a DC voltage V_{DC} through an AC/DC rectifier; converting the waved directional voltage V_{DC} to the less waved output DC voltage V_{LED}_{_{—}}_{DC} through a DC/DC converter for home power source (AC voltage source) usage; and doubling the AC voltage V_{AC} once to multi times through a plurality of double-voltage rectifier. The second embodiment of providing DC voltage source in the LED driving method is outputting V_{LED}_{_{—}}_{DC} converted directly from a DC voltage V_{DC} via a DC/DC converter. The third embodiment of providing DC voltage source in the LED driving method is outputting V_{LED}_{_{—}}_{DC} converted directly from an AC voltage V_{AC} via an AC/DC converter for home power source (AC voltage source) usage.

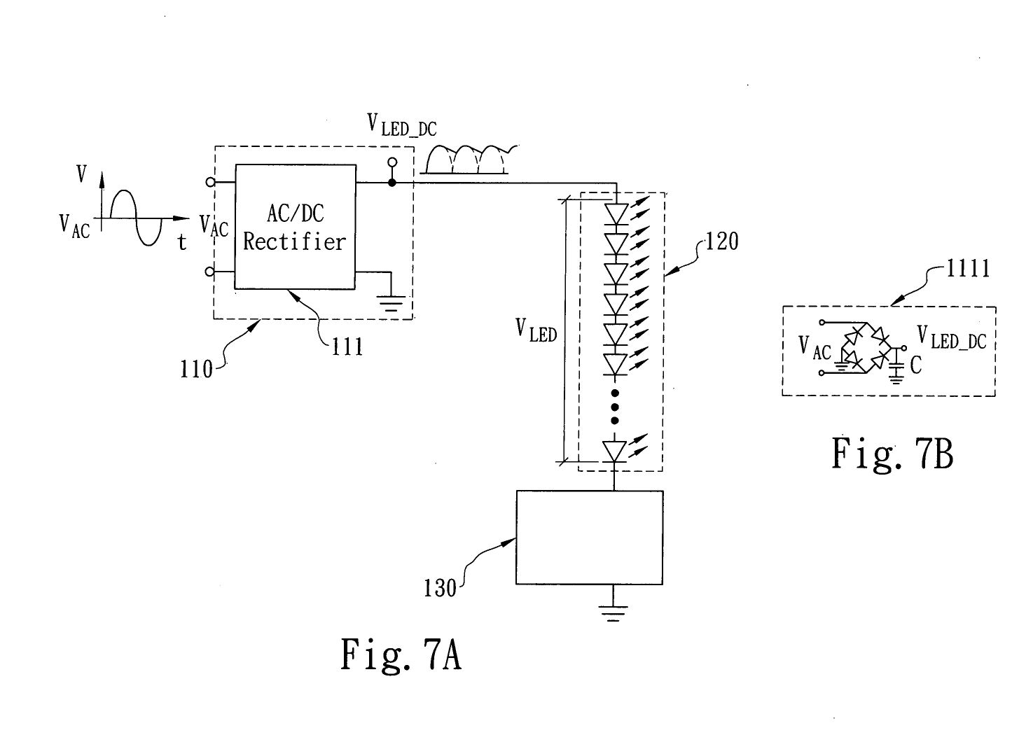

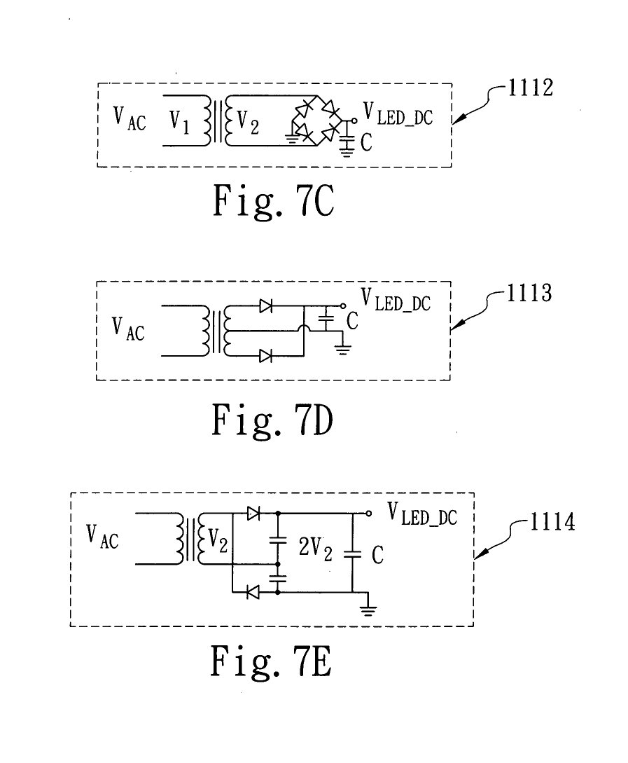

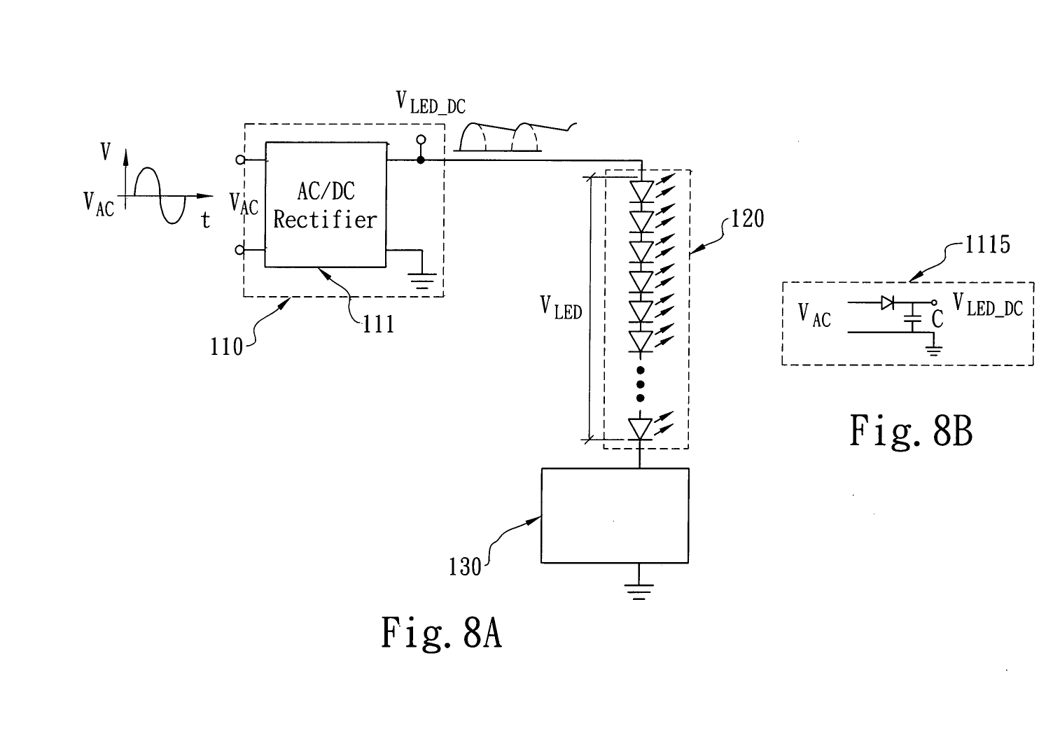

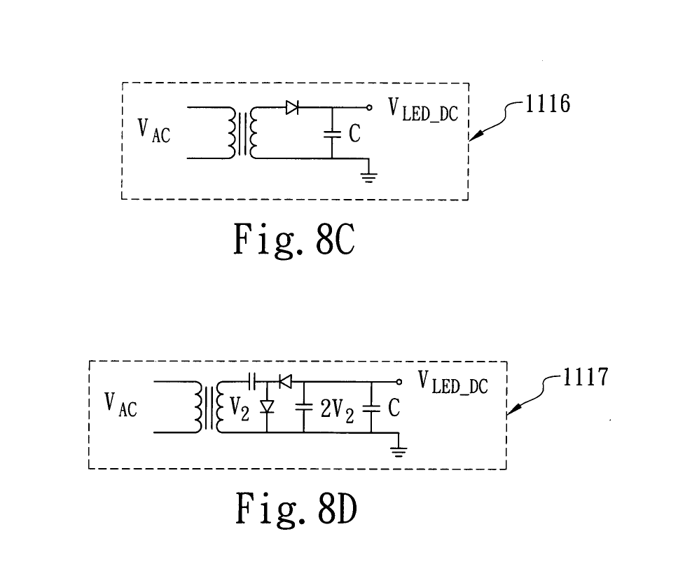

A light emitting diode (LED) driving system for constant luminance power according to the present invention comprises: a DC voltage source 110 for DC voltage supply V_{LED}_{_{—}}_{DC}, wherein the DC voltage source may consist of an AC/DC rectifier 111 for using home electric outlet (please see FIG. 7A-7E related to all bridge rectifier and FIG. 8A-8D related to half bridge rectifier); an LED set 120 connected to the DC voltage source for LED current I_{LED} generating; and a constant-voltage and constant-current regulator 130 connected with the LED set for LED voltage differential and current clamping even under any tough situation such as voltage spike, voltage and current ripples, rising ambient temperature or other factors to change luminance characters (I-V curve). Under the control of constant-voltage and constant-current regulator, the voltage differential and current of the LED set are clamped as V_{LED} and I_{LED}, and the luminance power P_{LED} is therefore clamped as V_{LED}*I_{LED}.

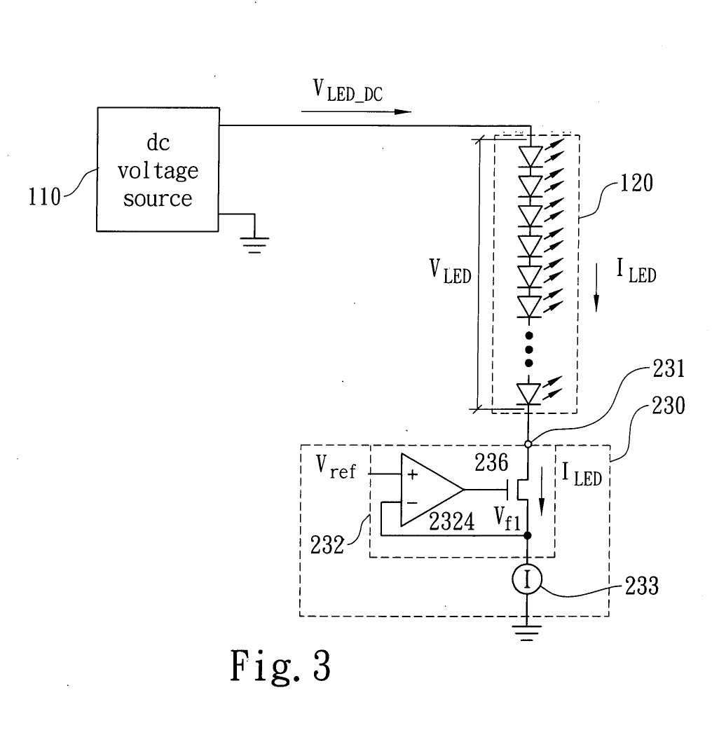

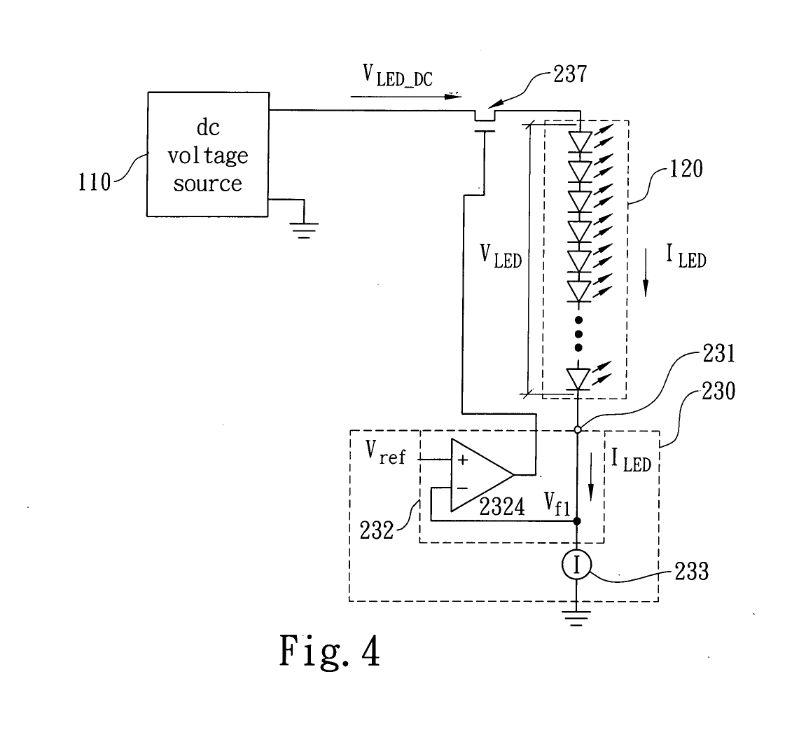

FIG. 3 shows how the voltage differential and current are clamped by the constant-voltage and constant-current regulator 230. It comprises: an output 231 for LED current I_{LED} acceptor; a constant-voltage circuit 232 connected to the output for the output voltage V_{f1} 231 clamping; a constant-current circuit 233 connected to the constant-voltage circuit for LED current I_{LED} clamping; and a constant-voltage transistor 236, 237 for extra voltage absorbing during voltage spike, ripple and so on. The constant-voltage circuit also comprises a constant-voltage operation amplifier (Op-Amp) 2324: with its positive input connected to the positive input of constant-voltage circuit for the reference voltage V_{ref} acceptor; with its negative input connected to the output of constant-voltage circuit; and with its gain output connected to the constant-voltage transistor's gate. The constant-voltage transistor 236, 237 and the constant-voltage Op-Amp 2324 form a feedback circuit to strictly clamp output voltage V_{f1} by a vary steady voltage, bandgap reference voltage, V_{ref}, and to dump extra voltage fluctuation to the constant-voltage transistor 236, 237.

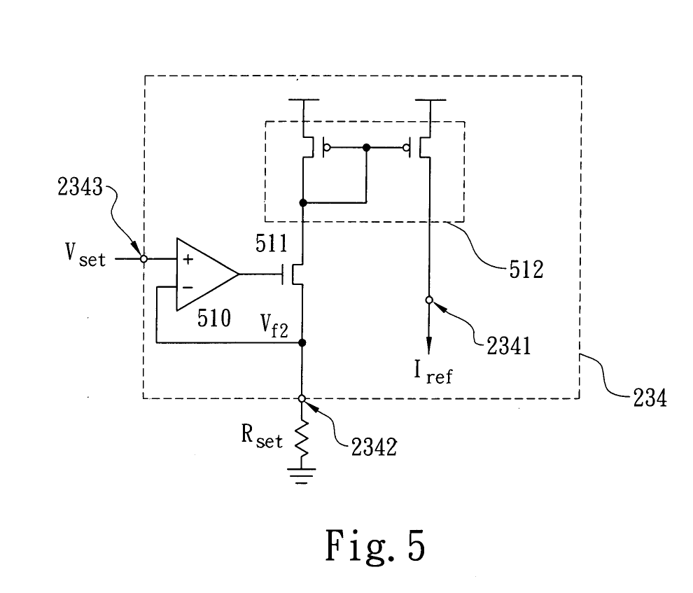

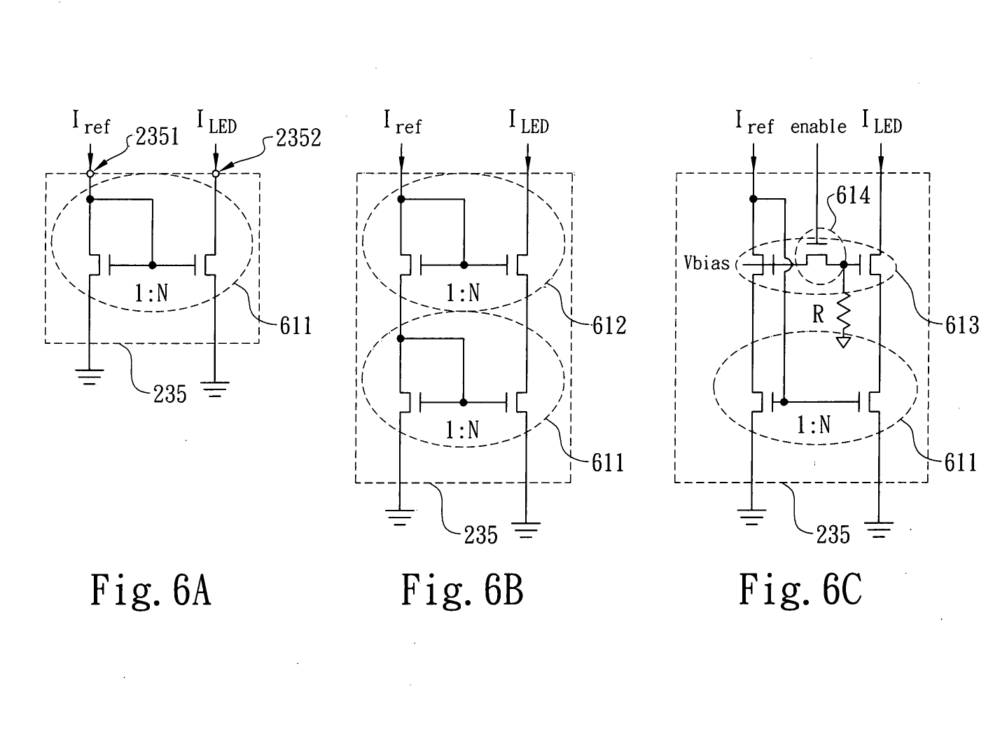

The constant-current circuit also comprises a current source 234 and a current sink 235. The current source is to generate a reference current I_{ref} and the current sink is to clamp LED current I_{LED} by the reference current I_{ref}. The current source (please see FIG. 5) comprises: a constant-current operation amplifier (Op-Amp) 510 with its positive input connected to the positive input 2343 of current source for the setting voltage Vₛₑₜ acceptor, with its negative input connected to the second output 2342 of current source (which is connected to ground through a setting resistor Rₛₑₜ) and also to a constant-current transistor's 511 source V_{f2}, and with its gain output connected to the constant-current transistor's gate; and a p channel current mirror 512 consisting of one pair of common-gate p channel transistors with its input drain connected to its common-gate and also the second output 2342 of the current source, and with its output drain connected to the first output 2341 of current source. The p channel current mirror copies current through its input drain to its output drain as reference current I_{ref}=V_{f2}/Rₛₑₜ. Because the output voltage of constant-current Op-Amp V_{f2} is controlled by the setting voltage Vₛₑₜ coming from a bandgap reference voltage and the voltage fluctuation at V_{f2} can be absorbed by the constant-current transistor 511, the reference current I_{ref}=V_{f2}/Rₛₑₜ is very steady to be a current source for the current sink. FIG. 6A-6C show different embodiments of the current sink. FIG. 6A is a first current mirror 611 consisting of one pair of common-gate transistors with its input drain connected to its common-gate and the first input 2351 of the current sink, and with its output drain connected to the second input 2352 of current sink for LED current I_{LED} acceptor. The LED current through the output drain of first current mirror is clamped as N times of the current through input drain of first current mirror (i.e. I_{ref}). FIG. 6B shows the current sink may also comprise a more second current mirror 612 as same as the first current mirror with its input drain disposed between the first input of the current sink 2351 and input drain of the first current mirror for reference current acceptor, and with its output drain disposed between the second input of current sink 2352 and output drain of the first current mirror for LED current I_{LED} acceptor. The current through output drain of second current mirror (i.e. I_{LED}) is clamped as N times of the current through input drain of second current mirror (i.e. I_{ref}). FIG. 6C shows the current sink may consist: a more pair of common-gate transistor 613 with its input drain disposed between the first input of the current sink and input drain of the first current mirror for reference current acceptor, and with its output drain disposed between the second input of current sink and output drain of the first current mirror for LED current I_{LED} acceptor; and a switch transistor 614 disposed on the common gate. Because the switch transistor can control LED's on and off by the gate voltage, LED's luminance power can also be controlled by the on-off frequency of the functional gate voltage.

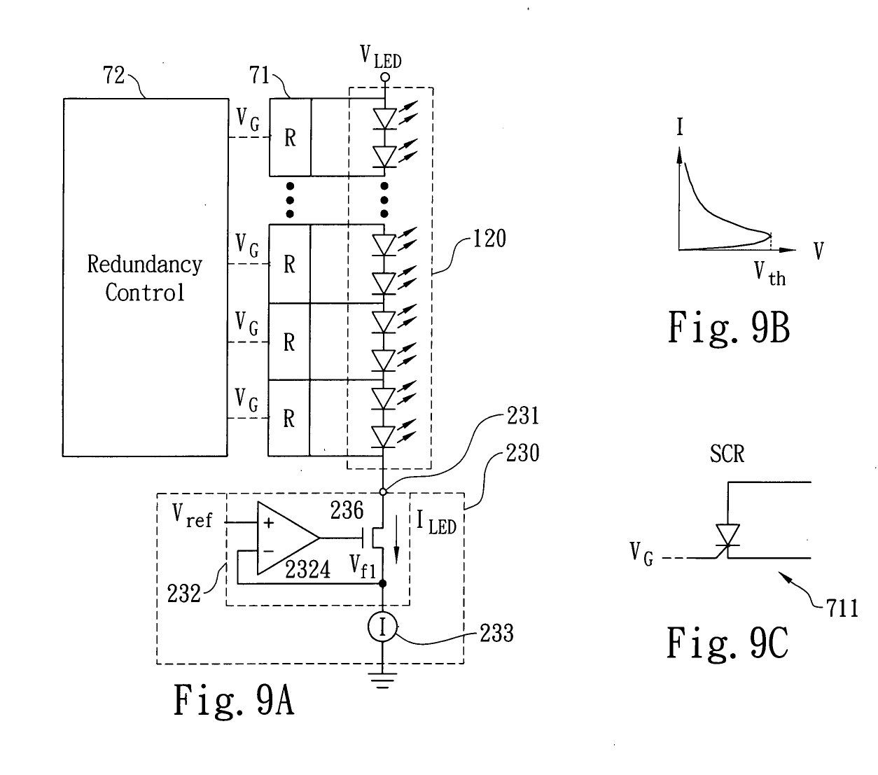

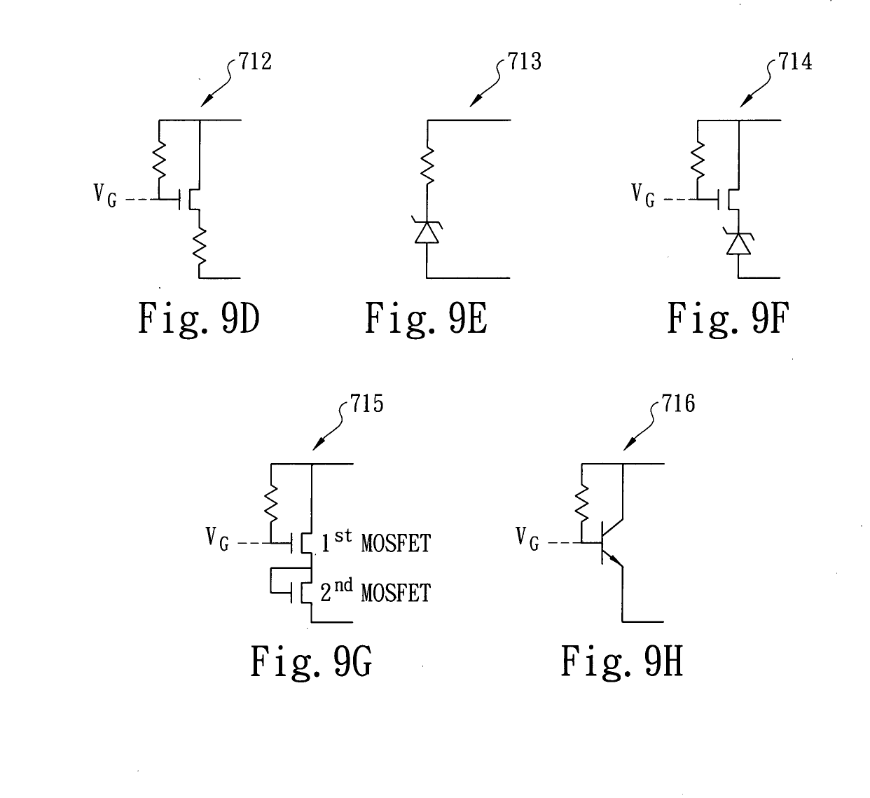

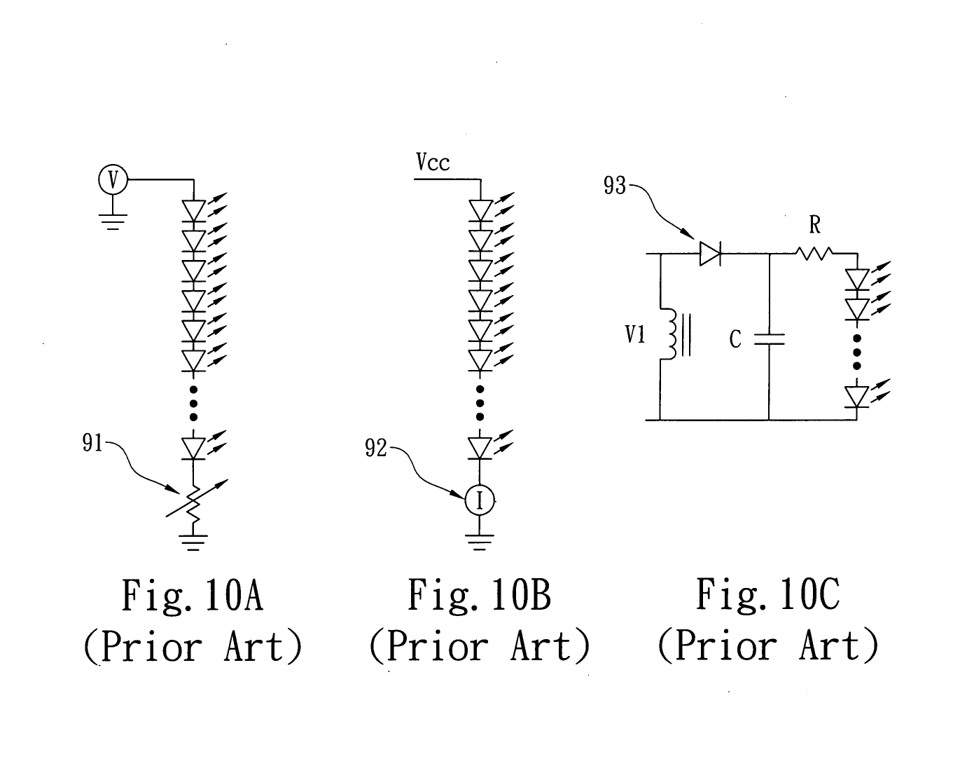

In order to avoid the terminating effect from harm LED during operation, a redundancy circuit (please see FIG. 9A) combined with a LED set is used as a LED current detour between any two nodes of the LED set. The detouring is controlled by a redundancy controller 72 when the voltage differential between the two nodes is higher than a threshold voltage Vₜₕ, where the Vₜₕ can be a fixed value or a flexible value. The redundancy circuit with fixed Vₜₕ may have a detour 71 consisting of a silicon controlled rectifier (SCR) connected with the LED set in parallel (please see FIG. 9C) whose gate is controlled by a gate current I_{G} from the redundancy controller for detour opening (please see FIG. 9B). The redundancy circuit with flexible Vₜₕ may have a detour comprising: a first metal oxide semiconductor field effect transistor (1^{st} MOSFET) connected with the LED set in parallel whose gate is controlled by a gate voltage V_{G} from the redundancy controller for detour opening; and a resistor disposed between gate and drain of the 1^{st} MOSFET for the threshold voltage Vₜₕ setting. In order to set voltage differential between two ends of the detour after detouring, a resistor, a zener diode, and a second metal oxide semiconductor field effect transistor (2^{nd} MOSFET) are disposed on the source of the 1^{st} MOSFET as FIG. 9D, FIG. 9F, and FIG. 9G individually. A zener diode as FIG. 9E connected with the LED set in parallel whose reverse bias current is conducted for detour opening when the voltage differential between the two nodes is higher than a threshold voltage Vₜₕ. A resistor connected with the zener diode in series is for threshold voltage Vₜₕ setting. Besides, a transistor as FIG. 9H connected with the LED set in parallel whose gate is controlled by a gate current I_{G} from the redundancy controller for detour opening. A base current from the redundancy controller is for setting voltage differential between two ends of the detour after detouring, and a resistor disposed between gate and drain of the transistor is for setting the threshold voltage Vₜₕ.

Accordingly, as disclosed by the above description and accompanying drawings, the present invention surely can accomplish its objective to provide a constant power LED driving method and system with strictly voltage and current clamping, and may be put into industrial use especially for mass product.

It should be understood that various modifications and variations could be made from the teaching disclosed above by the persons familiar in the art, without departing the spirit of the present invention.

What is claimed is:

1. A light emitting diode (LED) driving method for constant luminance power comprises the following steps:
(a) applying an output DC voltage V_{LED}_{_{—}}_{DC} from a DC voltage source on;
(b) providing an LED set to generate an LED current I_{LED} for LED luminance, wherein the LED current is controlled by; and
(c) providing a constant-voltage and constant-current regulator for LED voltage differential and current clamping even under any tough situation such as voltage spike, voltage and current ripples, rising ambient temperature or other factors to change luminance characters (I-V curve).

2. The LED driving method according to claim 1, wherein the constant-voltage and constant-current regulator perform the following steps:
(a) accepting the LED current though an output;
(b) clamping the output voltage V_{f} and absorbing extra voltage during voltage spike, ripple and so on via a constant-voltage circuit; and
(c) clamping the LED current I_{LED} via a constant-current circuit.

3. The LED driving method according to claim 2, wherein the constant-voltage and constant-current regulator further performs the following steps:
(a) outputting a reference current I_{ref} via a reference current source; and
(b) clamping the LED current I_{LED} via the reference current.

4. The LED driving method according to claim 2, wherein the constant-voltage and constant-current regulator further performs adjusting the output voltage V_{f} by an input reference voltage V_{ref}.

5. The LED driving method according to claim 3, wherein the constant-voltage and constant-current regulator further performs adjusting the reference current I_{ref} by a setting voltage Vₛₑₜ and a setting resistor Rₛₑₜ.

6. The LED driving method according to claim 3, wherein the constant-voltage and constant-current regulator performs setting a luminance switch by a functional gate voltage wherein the luminance switch controls the LED set on-and-off in functional frequency to fit the anticipant luminance power.

7. The LED driving method according to claim 1, wherein the LED set consists of a single LED.

8. The LED driving method according to claim 1, wherein the LED set consists of a plurality of LED string in series.

9. The LED driving method according to claim 1, wherein the DC voltage perform: converting an AC voltage V_{AC} to a DC voltage V_{DC} through an AC/DC rectifier; and converting the waved DC voltage V_{DC} to the less waved output DC voltage V_{LED}_{_{—}}_{DC} through a DC/DC converter in order to use home power source (AC voltage source) in LED driving.

10. The LED driving method according to claim 9, wherein the DC voltage source further perform: doubling the AC voltage V_{AC} once to multi times through a plurality of double-voltage rectifier

11. The LED driving method according to claim 1, wherein the DC voltage source outputs V_{LED}_{_{—}}_{DC} is converted from a DC voltage V_{DC} via a DC/DC converter.

12. The LED driving method according to claim 1, wherein the DC voltage source outputs V_{LED}_{_{—}}_{DC} is converted from an AC voltage V_{AC} via an AC/DC converter in order to use home power source (AC voltage source) in LED driving.

13. A light emitting diode (LED) driving system for constant luminance power comprises:
(a) a DC voltage source for DC voltage supply V_{LED}_{_{—}}_{DC};
(b) an LED set connected to the DC voltage source for generating LED current I_{LED}; and
(c) a constant-voltage and constant-current regulator connected with the LED set for LED voltage differential and current clamping even under any tough situation such as voltage spike, voltage and current ripples, rising ambient temperature or other factors to change luminance characters (I-V curve).

14. The LED driving system according to claim 13, wherein the constant-voltage and constant-current regulator further comprises:
(a) an output for LED current I_{LED} acceptor;
(b) a constant-voltage circuit connected to the output for the output voltage V_{f1} clamping; and
(c) a constant-current circuit connected to the constant-voltage circuit for LED current I_{LED} clamping.

15. The LED driving system according to claim 14, wherein the constant-voltage and constant-current regulator further comprises:
(a) a current source consisting of a first output for steady reference current I_{red} output; and
(b) a current sink consisting of a first input connected to the first output of current source for reference current I_{ref} acceptor, and a second input connected with the constant-voltage circuit's output for LED current I_{LED} acceptor, wherein the current through second input (i.e. I_{LED}) is clamped as I_{LED}=I_{ref}*N, where N is a set value.

16. The LED driving system according to claim 14, wherein the constant-voltage and constant-current regulator further comprises: a positive input on the constant-voltage circuit for reference voltage V_{ref} acceptor to control the value of clamping voltage V_{f1}.

17. The LED driving system according to claim 15, wherein the constant-voltage and constant-current regulator further comprises: a positive input on the current source for setting voltage Vₛₑₜ acceptor; and a second output on the current source connected with a setting resistor Rₛₑₜ to ground, wherein the second output voltage V_{f2} is controlled by the setting voltage Vₛₑₜ and the outlet current of the first output on current source is L_{ref}=V_{f2}/Rₛₑₜ.

18. The LED driving system according to claim 13, wherein the LED set consists of a single LED.

19. The LED driving system according to claim 13, wherein the LED set consists of a plurality of LED in series.

20. The LED driving system according to claim 13, wherein the DC voltage source comprises: an AC transformer providing an AC voltage V_{AC}; an AC/DC rectifier converting the AC voltage V_{AC} to a DC voltage V_{DC}; and a DC/DC converter converting the waved DC voltage V_{DC} to the less waved DC voltage source V_{LED}_{_{—}}_{DC} for using home power source on LED driving.

21. The LED driving system according to claim 20, wherein the DC voltage source further comprises: a plurality of double-voltage rectifier to double the AC voltage V_{AC} once to few times before entering the AC/DC rectifier.

22. The LED driving system according to claim 13, wherein the DC voltage source outputs V_{LED}_{_{—}}_{DC} from converting a DC voltage V_{DC} via a DC/DC converter.

23. The LED driving system according to claim 13, wherein the DC voltage source outputs V_{LED}_{_{—}}_{DC} from converting an AC voltage V_{AC} via a AC/DC converter for using home power source on LED driving.

24. The LED driving system according to claim 16, wherein the constant-voltage and constant-current regulator further comprises: a constant-voltage transistor disposed between the output and the output of constant-voltage circuit; and a constant-voltage operation amplifier (Op-Amp) with its positive input connected to the positive input of constant-voltage circuit for the reference voltage V_{ref} acceptor, with its negative input connected to the output of constant-voltage circuit, and with its gain output connected to the constant-voltage transistor's gate, wherein the constant-voltage transistor and Op-Amp form a feedback circuit for strictly clamping of output voltage V_{f1} by a vary steady voltage, bandgap reference voltage V_{ref}, and for dumping of extra voltage fluctuation on the constant-voltage transistor.

25. The LED driving system according to claim 16 further comprises: a constant-voltage transistor disposed between the DC voltage source and the LED set; and a constant-voltage operation amplifier (Op-Amp) with its positive input connected to the positive input of constant-voltage circuit for the reference voltage V_{ref} acceptor, with its negative input connected to the output of constant-voltage circuit, and with its gain output connected to the constant-voltage transistor's gate, wherein the constant-voltage transistor and Op-Amp form a feedback circuit for strictly clamping of output voltage V_{f1} by a vary steady voltage, bandgap reference voltage V_{ref}, and for dumping of extra voltage fluctuation on the constant-voltage transistor.

26. The LED driving system according to claim 17, wherein the constant-voltage and constant-current regulator further comprises: a constant-current Op-Amp with its positive input connected to the positive input of current source for the setting voltage Vₛₑₜ acceptor, with its negative input connected to the second output of current source, and with its gain output connected to its negative input to form a feedback circuit, wherein the setting voltage Vₛₑₜ is coming from a bandgap reference voltage to clamp voltage on the second output of the current source as V_{f2} for generating a steady current=V_{f2}/Rₛₑₜ; and a p channel current mirror consisting of one pair of common-gate p channel transistors with its input drain connected to its common-gate and the second output of the current source, and with its output drain connected to the first output of current source for current copy from the input drain to the output drain as reference current I_{ref}=V_{f2}/Rₛₑₜ.

27. The LED driving system according to claim 26, wherein the constant-voltage and constant-current regulator further comprises: a constant-current transistor disposed between the second output of current source and the input of p channel current mirror, wherein the connection between gain output and negative input of the constant-current Op-Amp is terminated, and the connection between the gain output and gate of the constant-current transistor is connected up to absorb the extra voltage on V_{f2} for steady current supply.

28. The LED driving system according to claim 15, wherein the constant-voltage and constant-current regulator further comprises: a first current mirror consisting of one pair of common-gate transistors with its input drain connected to the common-gate and the first input of the current sink, and with its output drain connected to the second input of current sink for LED current I_{LED} acceptor, wherein the current through output drain of first current mirror (i.e. I_{LED}) is clamped as N times of the current through input drain of first current mirror (i.e. I_{ref}).

29. The LED driving system according to claim 28, wherein the constant-voltage and constant-current regulator further comprises: a second current mirror as same as the first current mirror with its input drain disposed between the first input of the current sink and input drain of the first current mirror for reference current acceptor, and with its output drain disposed between the second input of current sink and output drain of the first current mirror for LED current I_{LED} acceptor, wherein the current through output drain of second current mirror (i.e. I_{LED}) is clamped as N times of the current through input drain of second current mirror (i.e. I_{ref}).

30. The LED driving system according to claim 28, wherein the constant-voltage and constant-current regulator further comprises: a pair of common-gate transistor of the current sink with its input drain disposed between the first input of the current sink and input drain of the first current mirror for reference current acceptor, and with its output drain disposed between the second input of current sink and output drain of the first current mirror for LED current I_{LED} acceptor; and a switch transistor disposed on gate of the pair of common-gate transistor of the current sink, wherein LED's on-off can be controlled by the gate voltage and LED's luminance power can also be controlled by the on-off frequency of the functional gate voltage.

31. A redundancy circuit combined with a LED set, for using as a LED current detour circuit between any two nodes of the LED set for LED protection and LED luminance maintenance, wherein the detouring is controlled by a redundancy controller when the voltage differential between the two nodes is higher than a threshold voltage Vₜₕ.

32. The redundancy circuit according to claim 31, wherein the threshold voltage Vₜₕ is fixed.

33. The redundancy circuit according to claim 31, wherein the threshold voltage Vₜₕ is flexible.

34. The redundancy circuit according to claim 31, wherein the detour circuit is a silicon controlled rectifier (SCR) connected with the LED set in parallel whose gate is controlled by a gate current I_{G} from the redundancy controller for detour opening.

35. The redundancy circuit according to claim 31, wherein the detour circuit comprises: a first metal oxide semiconductor field effect transistor (1^{st} MOSFET) connected with the LED set in parallel whose gate is controlled by a gate voltage V_{G} from the redundancy controller for detour opening; and a resistor disposed between gate and drain of the 1^{st} MOSFET for setting the threshold voltage Vₜₕ.

36. The redundancy circuit according to claim 35, wherein the detour circuit further comprises: a resistor connected with source of the 1^{st} MOSFET in series for setting voltage differential between two ends of the detour after detouring.

37. The redundancy circuit according to claim 35, wherein the detour circuit further comprises: a zener diode connected with source of the 1^{st} MOSFET in series for setting voltage differential between two ends of the detour after detouring.

38. The redundancy circuit according to claim 35, wherein the detour circuit comprises: a second metal oxide semiconductor field effect transistor (2^{nd} MOSFET) connected with source of the 1^{st} MOSFET in series for setting voltage differential between two ends of the detour after detouring.

39. The redundancy circuit according to claim 31, wherein the detour circuit comprises: a zener diode connected with the LED set in parallel whose reverse bias current is conducted for detour opening when the voltage differential between the two nodes is higher than a threshold voltage Vₜₕ; and a resistor connected with the zener diode in series for threshold voltage Vₜₕ setting.

40. The redundancy circuit according to claim 31, wherein the detour circuit comprises: a transistor connected with the LED set in parallel whose gate is controlled by a gate current I_{G} from the redundancy controller for detour opening and base is controlled by a base current from the redundancy controller for setting voltage differential between two ends of the detour after detouring; and a resistor disposed between gate and drain of the transistor for setting the threshold voltage Vₜₕ.
